(19) United States
(12) Patent Application Publication
(10) Pub. No.: US 2018/0063511 A1
(43) Pub. Date: Mar. 1, 2018

(54) APPARATUS AND METHOD FOR DETECTING OBJECT AUTOMATICALLY AND ESTIMATING DEPTH INFORMATION OF IMAGE CAPTURED BY IMAGING DEVICE HAVING MULTIPLE COLOR-FILTER APERTURE

(71) Applicant: CHUNG-ANG UNIVERSITY INDUSTRY-ACADEMY COOPERATION FOUNDATION, Seoul (KR)

(72) Inventors: Joon-Ki PAIK, Seoul (KR); Seung-Won Lee, Seoul (KR); Jung-Hyun Lee, Bucheon si Gyeonggi-do (KR)

(73) Assignee: CHUNG-ANG UNIVERSITY INDUSTRY-ACADEMY COOPERATION FOUNDATION, Seoul (KR)

(21) Appl. No.: 15/805,812

(22) Filed: Nov. 7, 2017

Related U.S. Application Data
(63) Continuation of application No. 14/376,770, filed on Aug. 5, 2014.

(30) Foreign Application Priority Data
Feb. 21, 2012 (KR) 10-2012-0017438
Apr. 24, 2012 (KR) 10-2012-0042770

(51) Int. Cl. H04N 13/02; H04N 5/232; H04N 9/07; H04N 5/225; G03B 9/02; G03B 11/00

(52) U.S. Cl. CPC H04N 13/0271; G06T 7/254; H04N 5/23254; H04N 9/07; H04N 5/2254; G06T 2207/30232; H04N 13/0214; G03B 9/02; G03B 11/00; G06T 2207/10024; G06T 7/55

(57) ABSTRACT

Disclosed are an apparatus and a method for detecting an object automatically and estimating depth information of an image captured by an imaging device having a multiple color-filter aperture. A background generation unit detects a movement from a current image frame among a plurality of continuous image frames captured by an MCA camera to generate a background image frame corresponding to the current image frame. An object detection unit detects an object region included in the current image frame based on differentiation between a plurality of color channels of the current image frame and a plurality of color channels of the background image frame. According to an embodiment of the present invention, it is possible to automatically detect an object by a repetitively updated background image frame and to accurately estimate object information by separately detecting an object for each color channel by considering a property of the MCA camera.

### CROSS-REFERENCE TO RELATED APPLICATION

The present application is a continuation application of U.S. application Ser. No. 14/376,770, filed on Aug. 5, 2014, and the present application claims priority to Korean applications KR 10-2012-0017438, filed on Feb. 21, 2012, and KR 10-2012-0042770, filed on Apr. 24, 2012, and international application PCT/KR2012/009308, filed on Nov. 7, 2012, which is incorporated herein by reference in its entirety.

### TECHNICAL FIELD

The present invention relates to an apparatus and method for detecting an object automatically and estimating depth information of an image captured by an imaging device having a multiple color-filter aperture, and more particularly, to an apparatus and method for detecting an object region automatically and estimating depth information from an image captured by an imaging device having an aperture having a plurality of color filters of different colors installed therein, that is, a multiple color-filter aperture (MCA).

### BACKGROUND ART

Much research has been conducted on a method of estimating three-dimensional depth information, which is used in a variety of fields, such as robot vision, human computer interface, intelligent visual surveillance, 3D image acquisition, intelligent driver assistant system, and so on.

Most conventional methods for 3D depth information estimation such as stereo vision depend on a plurality of images. Stereo matching is a method of estimating a depth by using binocular disparity that occurs in images obtained by two cameras. This method has a lot of advantages, but has a fundamental limitation in that a pair of images for the same scene, which are obtained by two cameras, are needed.

Research is also being conducted on a monocular method as an alternative of the method of using binocular disparity. As an example, a depth from defocus (DFD) method is a single camera-based depth estimation method, which estimates a degree of defocus blur by using a pair of images having different focuses that are captured from the same scene. However, the method has a limitation in that a fixed camera view is needed to capture a plurality of defocused images.

Thus, much research has been conducted on a method of estimating a depth by using one image, not a plurality of images.

Recently, a computational camera has been developed to obtain new information, which cannot have been obtained by an existing digital camera, and thus may provide new functionality to a consumer video device. The computational camera generates a final image by using a new combination of optics and calculation, and allows new image functions that cannot be achieved by an existing camera, such as an enhanced field of view, an increased spectral resolution, and an enlarged dynamic range.

Meanwhile, a color shift model using a multiple color-filter aperture (MCA) may provide depth information about objects positioned at different distances from a camera according to a relative direction and amount of shift between color channels of an image. However, existing MCA-based depth information estimation methods need a process of manually selecting an object region in an image in advance, in order to estimate object depth information.

### DISCLOSURE

### Technical Problem

The present invention is directed to providing an apparatus and method for detecting an object automatically and estimating depth information of an image captured by an imaging device having a multiple color-filter aperture, which can automatically detect an object from an image having a focus restored due to a shift characteristic of a color channel and estimate depth information on the detected object.

The present invention is also directed to providing a computer-readable recording medium storing a program for executing a method for automatically detecting an object and estimating depth information of an image captured by an imaging device having a multiple color-filter aperture, which can automatically detect an object from an image having a focus restored due to a shift characteristic of a color channel and estimate depth information on the detected object.

### Technical Solution

One aspect of the present invention provides an apparatus for automatically detecting an object of an image captured by an imaging device having a multiple color-filter aperture, the automatic object detection apparatus including: a background generation unit configured to detect a movement from a current image frame among a plurality of continuous image frames captured by an imaging device having different color filters installed in a plurality of openings formed in an aperture, to generate a background image frame corresponding to the current image frame; and an object detection unit configured to detect an object region included in the current image frame based on differentiation between a plurality of color channels of the current image frame and a plurality of color channels of the background image frame.

Another aspect of the present invention provides a method of automatically detecting an object of an image captured by an imaging device having a multiple color-filter aperture, the automatic object detection method including: a background generation step of detecting a movement from a current image frame among a plurality of continuous image frames captured by an imaging device having different color filters installed in a plurality of openings formed in an aperture, to generate a background image frame corresponding to the current image frame; and an object detection step of detecting an object region included in the current image frame based on differentiation between a plurality of color channels of the current image frame and a plurality of color channels of the background image frame.

Still another aspect of the present invention provides an apparatus for estimating depth information of an image captured by an imaging device having a multiple color-filter aperture, the depth information estimation apparatus including: a color shift vector calculation unit configured to calculate a color shift vector indicating a degree of color channel shift in an edge region extracted from color channels of an input image captured by an imaging device having different color filters installed in a plurality of openings formed in an aperture; and a depth map estimation unit configured to estimate a sparse depth map for the edge region by using a value of the estimated color shift vector, and interpolate depth information on a remaining region other than the edge region of the input image based on the sparse depth map to estimate a full depth map for the input image.

Yet another aspect of the present invention provides a method of estimating depth information of an image captured by an imaging device having a multiple color-filter aperture, the depth information estimation method including: calculating a color shift vector indicating a degree of color channel shift in an edge region extracted from color channels of an input image captured by an imaging device having different color filters installed in a plurality of openings formed in an aperture; estimating a sparse depth map for the edge region by using a value of the estimated color shift vector; and interpolating depth information on a remaining region other than the edge region of the input image based on the sparse depth map to estimate a full depth map for the input image.

### Advantageous Effects

With the apparatus and method for detecting an object automatically and estimating depth information of an image captured by an imaging device having a multiple color-filter aperture (MCA), it is possible to automatically detect an object by a repetitively updated background image frame and to accurately estimate object information by separately detecting an object for each color channel by considering a property of the MCA camera. It is also possible to estimate information on an actual depth from the camera to the object by using a property in which different color shift vectors are obtained according to positions of the object.

It is also possible to estimate a full depth map from one image captured by an imaging device having a multiple color-filter aperture (MCA) and to improve quality of the image by removing color-mismatching of the image by using the estimated full depth map. It is also possible to convert a 2D image into a 3D image by using the estimated full depth map.

### DESCRIPTION OF DRAWINGS

FIG. 1 is a view illustrating a configuration of an MCA camera.

FIGS. 2A-C are views illustrating a process of capturing an image by an MCA camera.

FIG. 3 is a block diagram illustrating a configuration of an apparatus for automatically detecting an object of an image captured by an imaging device having a multiple color-filter aperture according to a preferred embodiment of the present invention.

FIGS. 4A-C are views illustrating detection of an object according an embodiment of the present invention.

FIGS. 5A-B are views illustrating a positional relation between color channels and a color shift vector.

FIGS. 6A-B are graphs illustrating a normalized magnitude of each component of the color shift vector estimated for each continuous image frame.

FIG. 7 is a flowchart illustrating a method of automatically detecting an object of an image captured by an imaging device having a multiple color-filter aperture according to a preferred embodiment of the present invention.

FIG. 8 is a block diagram illustrating a configuration of an apparatus for estimating depth information of an image captured by an imaging device having a multiple color-filter aperture according to a preferred embodiment of the present invention.

FIG. 9 is a flowchart illustrating a method of estimating depth information of an image captured by an imaging device having a multiple color-filter aperture according to a preferred embodiment of the present invention.

### MODES OF THE INVENTION

An apparatus and method for detecting an object automatically and estimating depth information of an image captured by an imaging device having a multiple color-filter aperture according to a preferred embodiment of the present invention will be described below with reference to the accompanying drawings.

In order to describe a detailed configuration and operation of the present invention, a principle of an imaging device (hereinafter, referred to as an MCA camera) having a multiple color-filter aperture according to an embodiment of the present invention will be described, and then an operation of the present invention will be described in detail on an element-by-element basis.

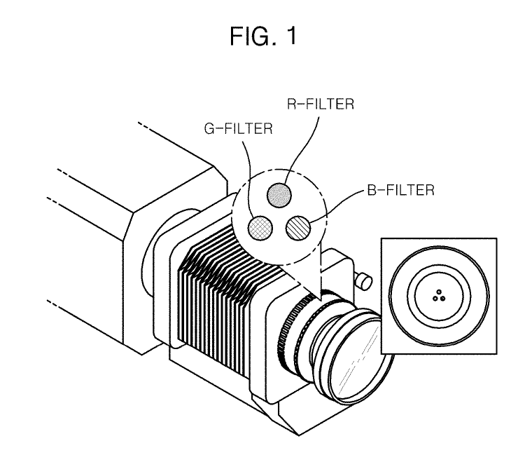

FIG. 1 is a view illustrating a configuration of an MCA camera. Referring to FIG. 1, an aperture inserted between lenses of the MCA camera includes three openings, and different color filters of red (R), green (G), and blue (B) are installed in the openings, respectively. The aperture has a center of the three openings, which is positioned on an optical axis.

Light forms an image at different positions of a camera sensor through the color filters installed in the respective openings according to a distance between a lens and an object. When the object is positioned at a position apart from a focal distance of the camera, color deviation occurs in the obtained image.

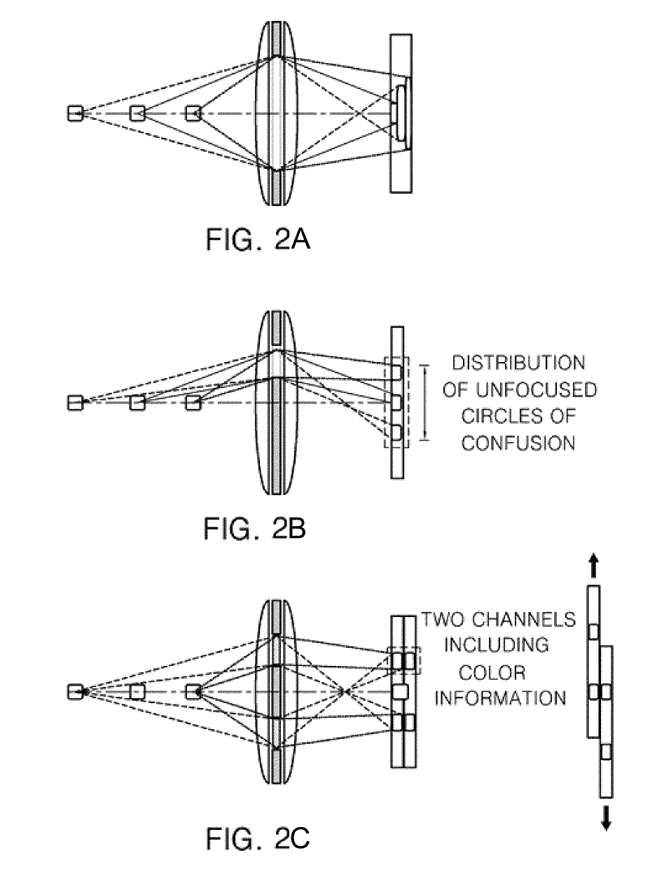

FIG. 2 is a view illustrating a process of capturing an image by an MCA camera.

When a center of openings of a general camera is aligned with an optical axis of a lens, a convergence pattern of an image plane forms a point or a circular region depending on a distance to a subject, as shown in a portion (a) of FIG. 2. On the other hand, when the center of openings is not aligned with the optical axis, the convergence region deviates from the optical axis, as shown in a portion (b) of FIG. 2. A specific region where light is collected varies depending on a distance between the lens and the subject. For example, a subject closer than a focal position is converged at an upper portion of the optical axis while a subject farther than the focal position is converged at a lower portion of the optical axis. An offset from the optical axis may generate a focal pattern of an image. Referring to a portion (c) of FIG. 2, it can be seen that, when two openings are positioned at one side of the optical axis, a convergence pattern of a subject positioned at a remote distance is formed at an opposite side in an imaging sensor.

The present invention has a configuration for automatically detecting an object from an image by using color deviation that occurs in an image captured by the MCA camera and also estimating information on a depth from the MCA camera to the object on the basis of a degree of color deviation.

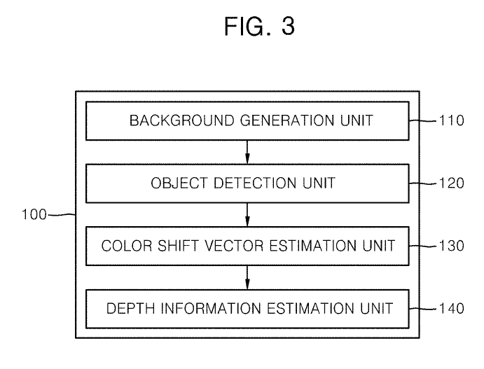

FIG. 3 is a block diagram illustrating a configuration of an apparatus for automatically detecting an object of an image captured by an imaging device having a multiple color-filter aperture according to a preferred embodiment of the present invention.

Referring to FIG. 3, an automatic object detection apparatus 100 according to an embodiment of the present invention includes a background generation unit 110, an object detection unit 120, a color shift vector estimation unit 130, and a depth information estimation unit 140.

The background generation unit 110 detects a movement from a current image frame among a plurality of continuous image frames that are captured by the MCA camera and generates a background image frame corresponding to the current image frame. That is, the automatic object detection apparatus 100 according to an embodiment of the present invention may generate a background and detect an object in real time for each image frame of a video image configured of a plurality of continuous image frames.

The background generation unit 110 may estimate movement of a current image frame by using an optical flow in order to generate a background image frame corresponding to the current image frame. Optical flow information corresponding to respective pixels of the current image frame may be obtained from a relation between the current image frame and a previous image frame before the current image frame, as expressed in Equation 1 below.

D(c,y)=Σ_{i=x-w}^{x+w}Σ_{j=y-w}^{y+w}(fᵢ(i,j)−fᵢ₋₁(i+dₓ, j+d_{y}))² [Equation 1]

where, D(x,y) is optical flow information corresponding to a pixel (x,y) of the current image frame, fₜ is the current image frame, fₜ₋₁ is the previous image frame, and (dₓ,d_{y}) is a value for minimizing D(x,y) and indicates shift of the pixel (x,y). In Equation 1, a size of a search region is set as (2w+1)x(2w+1).

If a value of the optical flow information D(x,y) in the pixel (x,y) of the current image frame is less than a predetermined Euclidean distance threshold, the corresponding pixel is determined to be included in the background. The background generation unit 110 updates a background image frame generated corresponding to the previous image frame, as expressed in Equation 2 below, by using pixels of the current image frame that are determined to be included in the background.

f_{B}^{t}(x,y)=(1−α)f^{t}(x,y)+αf_{B}^{t-1}(x,y) [Equation 2]

where, f_{B}^{t} and f_{B}^{t-1} are background image frames corresponding to the current image frame and the previous image frame, respectively, and α is a predetermined mixing ratio in a range of [0,1].

The object detection unit 120 detects an object region included in the current image frame on the basis of differentiation between the current image frame and the background image frame of the current image frame. In conventional methods, only differentiation between image frames is calculated to detect an object. However, the object detection unit 120 of the automatic object detection apparatus 100 according to an embodiment of the present invention detects an object region for each color channel of the current image frame by calculating the differentiation between a plurality of color channels constituting the current image frame and the background image frame.

For example, if differentiation between a channel R of a current image frame and a channel R of a background image frame is calculated, an object region corresponding to the channel R of the current image frame is obtained, and object regions corresponding to channels G and B are obtained using the same process, respectively. By detecting an object region for each color channel of an image frame, as shown in FIG. 2, a characteristic of an MCA camera, such as color deviation occurring when a position of the object does not match a focal distance, may be reflected to the object detection process.

Specifically, the object detection unit 120 may detect an object region from the current image frame, as expressed in Equation 3 below.

$${f}_{O}^{c} ( x , y ) = \{ \begin{matrix}1 , & \vert {f}_{B}^{c} ( x , y ) - {f}^{c} ( x , y ) > {θ}_{B} \\ 0 , & otherwise\end{matrix} \} , \\ for c ∈ \{ R , G , B \} \qquad [ Equation 3 ]$$

where, f_{O}^{c} is a binary image corresponding to a color channel of the current image frame, which represents an object region where pixels having a value of 1 in f_{O}^{c} are detected from the corresponding color channel

After detecting the object region, the object detection unit 120 may additionally remove noise from object regions positioned at close points for each color channel, by using an object morphological filter.

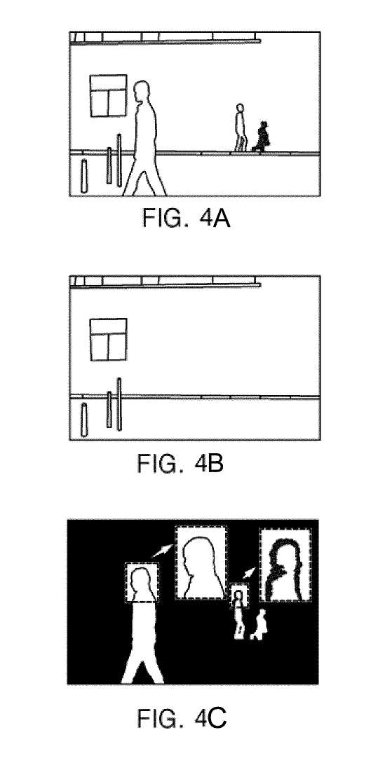

FIG. 4 is a view illustrating detection of an object according an embodiment of the present invention. Specifically, a portion (a) of FIG. 4 illustrates a current image frame. A portion (b) of FIG. 4 illustrates a background image frame corresponding to the current image frame. A portion (c) of FIG. 4 illustrates a detected object region.

As shown in the portion (a) of FIG. 4, the current image frame includes a plurality of objects. Referring to the portion (c) of FIG. 4, it can be seen that color deviation does not occur in a focused object region, but occurs in an unfocused object region due to the above-described color deviation characteristic according to a distance from the MCA camera to the object.

Meanwhile, the automatic object detection apparatus 100 according to an embodiment of the present invention may estimate depth information, which is information about a distance from the MCA camera to the object corresponding to the object region, by using a degree of color shift that is included in an object region detected by the object detection unit 120.

In order to estimate the object depth information, a channel alignment process should be performed on an object region where deviation occurs between color channels as described above. The color channel alignment process may be performed by estimating color shift vectors (CSVs) that indicate information on directions and distances of other color channels (for example, a channel R and a channel B) with respect to a specific color channel (for example, a channel G).

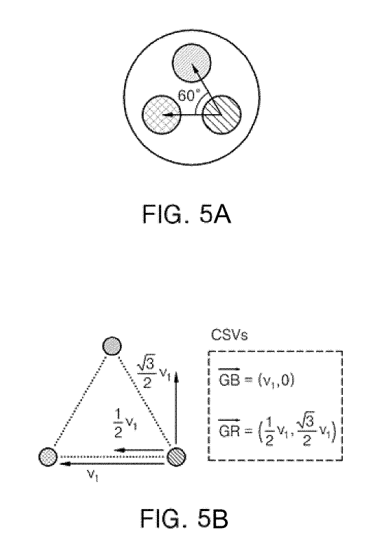

FIG. 5 is a view illustrating a positional relation between color channels and a color shift vector. As shown in a portion (a) of FIG. 5, color channels in the aperture of the MCA camera may be positioned at vertices of a regular triangle and configured to accurately estimate depth information of an object while reducing a calculation amount for estimating the depth information by using such a characteristic. When a plurality of object regions are detected from the current image frame, a process of estimating a color shift vector and object depth information, which will be described below, is performed on each objection region.

Specifically, color shift vectors of the channel R and the channel B with respect to the channel G in an i-th object region of a plurality of object regions are expressed as Equation 4 below.

f^{G}(x,y)=f^{B}(x+Δx_{GB}, y+Δy_{GB})

f^{G}(x,y)=f^{R}(x+Δx_{GR}, y+Δy_{GR}) [Equation 4]

where, (Δx_{GB},Δy_{GB}) and (Δx_{GR},Δy_{GR}) indicate a color shift vector for a GB channel (a channel G and a channel B) and a color shift vector for a GR channel (a channel G and a channel R), respectively. The two color shift vectors as expressed in Equation 4 have a relation as expressed in Equation 5, because of a property of the MCA camera as shown in the portion (a) of FIG. 5.

$$[ \begin{matrix}Δ {x}_{GR} \\ Δ {y}_{GR}\end{matrix} ] = [ \begin{matrix}cos ( - 60 ° ) & - sin ( - 60 ° ) \\ sin ( - 60 ° ) & cos ( - 60 ° )\end{matrix} ] [ \begin{matrix}Δ {x}_{GB} \\ Δ {y}_{GB}\end{matrix} ] = [ \begin{matrix}\frac{1}{2} Δ {x}_{GB} + \frac{\sqrt{3}}{2} Δ {y}_{GB} \\ - \frac{\sqrt{3}}{2} Δ {x}_{GB} + \frac{\sqrt{3}}{2} Δ {y}_{GB}\end{matrix} ] \qquad [ Equation 5 ]$$

In this case, the color shift vectors (Δx_{GB},Δy_{GB}) and (Δx_{GR},Δy_{GR}) may be estimated by minimizing quadratic error functions of Equation 6.

$${E}^{GB} ( Δ {x}_{GB} , Δ {y}_{GB} ) = {\sum }_{( x , y ) ∈ Ω} [ {f}^{G} ( x , y ) - {{f}^{B} ( x + Δ {x}_{GB} , y + Δ {y}_{GB} ]}^{2} , \\ {E}^{GR} ( Δ {x}_{GB} , Δ {y}_{GB} ) = {\sum }_{( x , y ) ∈ Ω} [ {f}^{G} ( x , y ) - {{f}^{R} ( x + Δ {x}_{GR} , y + Δ {y}_{GR} ]}^{2} , = {\sum }_{( x , y ) ∈ Ω} [ {f}^{G} ( x , y ) - {{f}^{R} ( x + \frac{1}{2} Δ {x}_{GB} + \frac{\sqrt{3}}{2} Δ {y}_{GB} , y - \frac{\sqrt{3}}{2} Δ {x}_{GB} + \frac{1}{2} Δ {y}_{GB} ]}^{2} \qquad [ Equation 6 ]$$

where, E^{GB} is an error function corresponding to a color shift vector of the GB channel, E^{GB} is an error function corresponding to a color shift vector of the GR channel, and Ω is an object region. Referring to Equation 6, the error function corresponding to the color shift vector of the GR channel may be represented using the color shift vector of the GB channel with reference to a relation the above-described color shift vectors.

As a result, the error function of Equation 6 is a nonlinear function of (Δx_{GB},Δy_{GB}), and thus an iterative approach method such as Newton-Raphson algorithm may be used to find (Δx_{GB},Δy_{GB}) that minimizes Equation 6.

Estimation of a linear Taylor series for the error functions of Equation 6 may be represented as expressed in Equation 7 below.

$${E}^{GB} ( Δ {x}_{GB} , Δ {y}_{GB} ) \approx {\sum }_{( x , y ) ∈ Ω} {[ {f}_{t}^{GB} ( x , y ) - Δ {x}_{GB} {f}_{x}^{GB} ( x , y ) - Δ {y}_{GB} {f}_{y}^{GB} ( x , y ) ]}^{2} , \\ {E}^{GB} ( Δ {x}_{GB} , Δ {y}_{GB} ) \approx {\sum }_{( x , y ) ∈ Ω} [ {f}_{t}^{GR} ( x , y ) - ( \frac{1}{2} Δ {x}_{GB} + \frac{\sqrt{3}}{2} Δ {y}_{GB} ) {f}_{x}^{GR} ( x , y ) - {( - \frac{\sqrt{3}}{2} Δ {x}_{GB} + \frac{1}{2} Δ {y}_{GB} {f}_{y}^{GR} ( x , y ) ]}^{2} \qquad [ Equation 7 ]$$

where, for a color channel c∈{R,B}, fₜ^{Gc}(x,y)=f^{G}(x,y)−f^{c}(x,y), and fₓ^{Gc}(•) and f_{y}^{Gc}(•) are a horizontal derivative and a vertical derivative of 1/2{f^{G}(x,y)+f^{c}(x,y)}, respectively.

The estimated error is represented in the form of a vector, as expressed in Equation 8 below.

$${E}^{GB} ( \vec{v} ) = {\sum }_{x , y ∈ Ω} {[ {\vec{s}}^{GB} - {\vec{c}}^{GB} - \vec{v} ]}^{2} \\ {E}^{GR} ( \vec{v} ) = {\sum }_{x , y ∈ Ω} {[ {\vec{s}}^{GR} - {\vec{c}}^{GR} - \vec{v} ]}^{2} \\ where , s = ft , \vec{v} = {[ Δ {x}_{GB} , Δ {y}_{GB} ]}^{T} , \\ {c}^{GB} = {[ {f}_{x} , {f}_{y} , ]}^{T} , and \\ {c}^{GR} = {[ \frac{1}{2} {f}_{x}^{GR} - \frac{\sqrt{3}}{2} {f}_{y}^{GR} , \frac{\sqrt{3}}{2} {f}_{x}^{GR} - \frac{1}{2} {f}_{y}^{GR} , ]}^{T} \qquad [ Equation 8 ]$$

Since E(v) is a quadratic function of a vector v, v for minimizing an error may be obtained by finding a value of allowing a result obtained by differentiating an error function with respect to v to be zero, as expressed in Equation 9.

$$\frac{{dE}^{GB} ( v )}{dv} = - {\sum }_{x , y ∈ Ω} 2 {c}^{GB} [ {s}^{GB} - {x}^{GB} v ] \\ \frac{{dE}^{GR} ( v )}{dv} = - {\sum }_{x , y ∈ Ω} 2 {c}^{GR} [ {s}^{GR} - {x}^{GR} v ] \qquad [ Equation 9 ]$$

Since Equation 9 is a linear equation, the vector v may be obtained as expressed in Equation 10 below.

v=[Σ_{x,y∈Ω}CC^{T}]⁻¹[Σ_{x,y∈Ω}CS] [Equation 10]

where, C=(c^{GB}, c^{GR}) and S=(s^{GB}, s^{GR})^{T}. If a size of the detected object region is sufficiently large and sufficient contents are included in an image, a matrix C may have an inverse matrix in Equation 10.

Equation 10 may be further simplified based on a characteristic of the MCA camera. If the channel G and the channel B have the same horizontal axis, Δy_{GB}, a vertical component of the color shift vector, is equal to zero. Accordingly, the vector v may be represented with a single parameter Δx_{GB} by using triangle properties and an angle between color filters of an aperture, as shown in a portion (b) of FIG. 5, as expressed in Equation 11 below.

$${v}_{1} = \frac{{\sum }_{x , y ∈ Ω} {C}^{′} S}{{\sum }_{x , y ∈ Ω} {C}^{′} {C}^{′ T}} where , {C}^{′} = ( {c}^{′ GB} , {c}^{′ GR} ) , {c}^{′ GB} = {f}_{x} , and \\ {c}^{′ GR} = \frac{1}{2} {f}_{x}^{GR} - \frac{\sqrt{3}}{2} {f}_{y}^{GR} . \qquad [ Equation 11 ]$$

Each of a numerator and a denominator of Equation 11 may be a 1×1 matrix and estimate a final shift vector v, which is a combination between color shift vectors that are estimated by corresponding to color channels without an inverse matrix, respectively.

The automatic object detection apparatus 100 according to an embodiment of the present invention may further include the depth information estimation unit 140 for estimating information on an absolute depth from the MCA camera to the object. The depth information estimation unit 140 estimates information on a depth between the MCA camera and the object included in the object region on the basis of magnitude information of the final shift vector v.

Specifically, a conversion function indicating a distance to the object and a shift amount of the color channel, that is, a relation between magnitudes of shift vectors may be predetermined. The conversion function may be obtained by positioning objects at certain distances from the MCA camera, repetitively capturing the same scene including an object for each position of the object, and estimating a color shift vector.

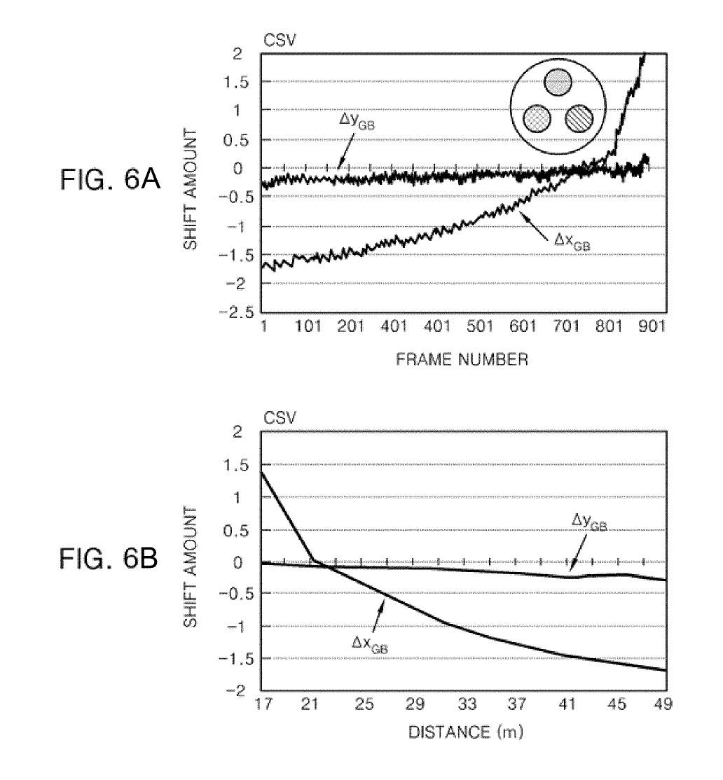

FIG. 6 is a graph illustrating a normalized magnitude of each component of the color shift vector estimated for each continuous image frame. A portion (a) of FIG. 6 illustrates magnitude information of the color shift vector according to an image frame number. A portion (b) of FIG. 6 illustrates magnitude information of the color shift vector according to a distance from the MCA camera to the object.

Referring to the portion (a) of FIG. 6, it can be seen that, as the object is closer to the focal position (about 21 meters) of the MCA camera, that is, an image frame number increases, the magnitude of the shift vector is converged to zero. If the object approaches the MCA camera through the focal position, the magnitude of the shift vector is divergent as shown in the portion (a) of FIG. 6. The portion (b) of FIG. 6 illustrates the magnitude of the shift vector by quantizing the distance from the MCA camera to the object in units of 1 meter.

When a graph has been established as shown in the portion (b) of FIG. 6, the depth information estimation unit 140 may estimate information on an accurate depth to the object included in the object region by substituting information on the magnitude of the shift vector corresponding to the object region detected from the current image frame, for the graph.

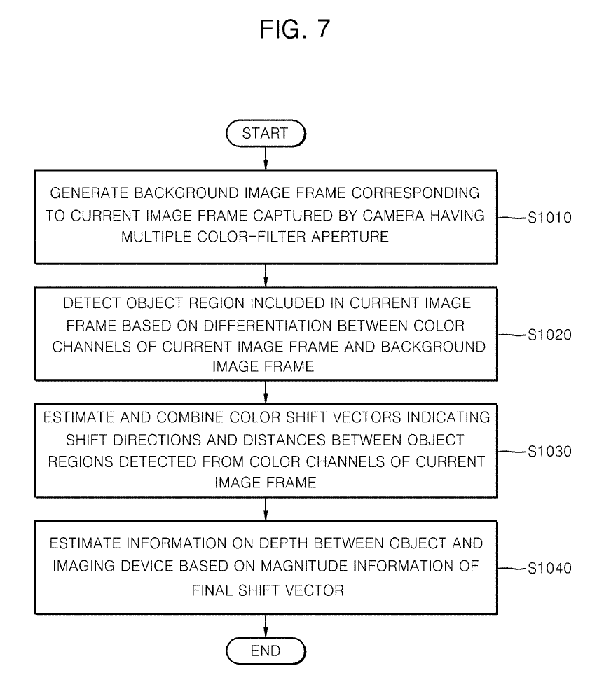

FIG. 7 is a flowchart illustrating a method of automatically detecting an object of an image captured by an imaging device having a multiple color-filter aperture according to a preferred embodiment of the present invention.

Referring to FIG. 7, the background generation unit 110 detects a movement from a current image frame among a plurality of continuous image frames that are captured by the MCA camera and generates a background image frame corresponding to the current image frame in operation S1010. The object detection unit 120 detects an object region included in the current image frame on the basis of differentiation between respective color channels of the current image frame and respective color channels of the background image frame in operation S1020. Thus, the present invention may detect an object region in real time whenever an image frame is input. This process may be automatically performed without predetermining an object part.

Further, the color shift vector estimation unit 130 estimates color shift vectors each indicating a shift direction and a distance between the object regions detected from color channels of the current image frame, and calculates a final shift vector corresponding to an object region by combining the color shift vectors estimated corresponding to color channels in operation S1030.

The depth information estimation unit 140 may estimate information on a depth to an object included in the object region on the basis of magnitude information of the final shift vector in operation S1040. As described above, it is preferable that a conversion function between the magnitude information of the shift vector and the distance information be predetermined.

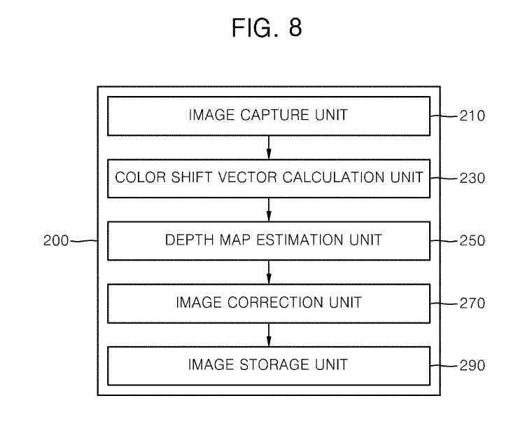

FIG. 8 is a block diagram illustrating a configuration of an apparatus for estimating depth information of an image captured by an imaging device having a multiple color-filter aperture according to a preferred embodiment of the present invention.

Referring to FIG. 8, a depth information estimation apparatus 200 according to an embodiment of the present invention includes an image capture unit 210, a color shift vector calculation unit 230, a depth map estimation unit 250, an image correction unit 270, and an image storage unit 290. The image capture unit 210 may be implemented to be a separate device, independent of the depth information estimation apparatus 200. In this case, the depth information estimation apparatus 200 according to an embodiment of the present invention receives an image from the image capture unit 210 and performs operations of estimating depth information of the image and improving quality of the image.

The image capture unit 210 includes a capture module (not shown) and captures a surrounding scene to obtain an image. The capture module includes an aperture (not shown), a lens unit (not shown), and an imaging device (not shown). The aperture is disposed in the lens unit, and configured to include a plurality of openings (not shown) and adjust an amount of light incident on the lens unit according to a degree of openness of the openings. Each opening includes a red color filter, a green color filter, and a blue color filter. The capture module measures depth information of objects positioned at different distances and performs multi-focusing by using a multiple color-filter aperture (MCA). Since the multi-focusing has been described with reference to FIGS. 1 and 2, its detailed description will be omitted.

The color shift vector calculation unit 230 calculates a color shift vector indicating a degree of color filter shift in an edge region that is extracted from a color channel of the image received from the image capture unit 210.

For example, the color shift vector calculation unit 230 calculates color shift vectors of a green color channel and a blue color channel with respect to a red color channel in an edge region extracted from the color channel of the input image by using a normalized cross correlation (NCC) combined with a color shifting mask map (CSMM), as expressed in Equation 12 below. Alternatively, color shift vectors of other color channels with respect to the green color channel or blue color channel among the three color channels.

CSV(x,y)^{arg max C}^{_{N}}^{(u,v)}_{u,v}subject CSMM(u,v)=1 [Equation 12]

where, CSV(x,y) is a color shift vector estimated at (x,y), C_{N}(u,v) is a value obtained by the normalized cross correlation (NCC), and CSMM(u,v) is the color shifting mask map (CSMM), which is predetermined based on a color shifting property of the multiple color-filter aperture (MCA) in which a color channel is shifted in a predetermined form.

Specifically, the normalized cross correlation (NCC) is expressed in Equation 13 below. Thus, fast block matching may be performed.

$${C}_{N} ( u , v ) = \frac{{\sum }_{x , y} \{ {f}_{1} ( x , y ) - {\overline{f}}_{1} \} \{ {f}_{2} ( x - u , y - v ) - {\overline{f}}_{2} \}}{\begin{matrix}\sqrt{{\sum }_{x , y} {\{ {f}_{1} ( x , y ) - {\overline{f}}_{1} \}}^{2}} \\ \sqrt{{\sum }_{x , y} {\{ {f}_{2} ( x - u , y - v ) - {\overline{f}}_{2} \}}^{2}}\end{matrix}} \qquad [ Equation 13 ]$$

where, f₁(x,y) is a block in the red color channel, and f₂(x,y) is a block in the green color channel or blue color channel. The normalized cross correlation (NCC) of Equation 13 may be efficiently evaluated by using a fast Fourier transform (FFT).

An error in disparity estimated by an edge-based NCC may be reduced because of different intensity levels between erroneously detected edges and color channels by enforcing the color shifting property of the multiple color-filter aperture (MCA) in the color shifting mask map (CSMM). That is, the disparity may be accurately estimated by applying a priori constraint to a feasible pattern of color shift vectors (CSVs).

The color shift vector calculation unit 230 selects, as a color shift vector for an input image, a color shift vector having a high matching ratio among the calculated two color shift vectors.

The depth map estimation unit 250 estimates a sparse depth map for the input image, as expressed in Equation 14 below, by using the color shift vector (CSV) for the input image that is estimated by the color shift vector calculation unit 230.

D(x,y)=−sign(v)×\sqrt{u²+v²} [Equation 14]

where, (u,v) is a color shift vector estimated at (x,y), and sign(v) is a sign of v.

The depth map estimation unit 250 estimates a full depth map for the input image from the sparse depth map that is estimated using the color shift vector (CSV), by using a depth interpolation method. That is, the depth map estimation unit 250 estimates a full depth map by filling a remaining portion of the image by using the matting Laplacian method, in order to generate a full depth map by using the sparse depth map detected in the edge region.

Specifically, the depth interpolation is performed by minimizing an energy function as expressed in Equation 15 below.

E(d)=d^{T}Ld+λ(d−\hat{d})^{T}A(d−\hat{d}) [Equation 15]

where, d is a full depth map, \hat{d} is a sparse depth map, L is a matting Laplacian matrix, A is a diagonal matrix in which Aᵢᵢ is equal to 1 if an i-th pixel is on an edge and Aᵢᵢ is equal to 0 if an i-th pixel is not on an edge, and λ is a constant for controlling fidelity between smoothness of interpolation and a sparse depth map.

The matting Laplacian matrix L is defined as expressed in Equation 16 below.

$$L ( i , j ) = {\sum }_{k \vert ( i , j ) ∈ {w}_{k}} ( {δ}_{ij} - \frac{1}{\vert {w}_{k} \vert} ( 1 + {( {I}_{i} - {µ}_{k} )}^{T} {( {\sum }_{k} - \frac{ɛ}{\vert {w}_{k} \vert {U}_{3}} )}^{- 1} ( ( {I}_{i} - {µ}_{k} ) ) ) ) \qquad [ Equation 16 ]$$

where, δᵢⱼ is a Kronecker delta function, U is a 3×3 identity matrix, μₖ is a mean of colors in a window wₖ, Σₖ is a covariance matrix of colors in a window wₖ, Iᵢ and Iⱼ are colors of an input image I at pixels i and j, respectively, ε is a regularization parameter, and |wₖ| is a magnitude of a window wₖ.

The full depth map is obtained as expressed in Equation 17 below.

d=(L+λA)⁻λ\hat{d} [Equation 17]

The image correction unit 270 corrects the input image to a color-matched image by shifting a color channel of the input image using the full depth map estimated by the depth map estimation unit 250. Thus, it is possible to improve image quality by correcting a color-mismatched image using a full depth map for an input image. The image correction unit 270 may correct the input image to a 3D image by using the full depth map.

The image storage unit 290 stores the image corrected by the image correction unit 270 and a corresponding full depth map.

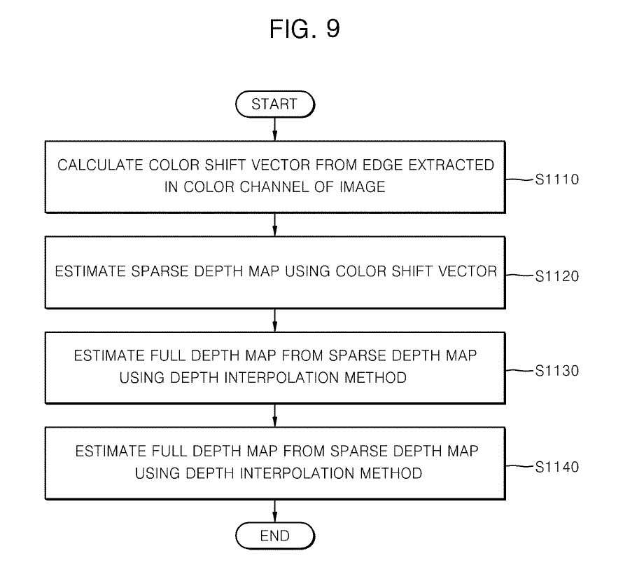

FIG. 9 is a flowchart illustrating a method of estimating depth information of an image captured by an imaging device having a multiple color-filter aperture according to a preferred embodiment of the present invention.

The depth information estimation apparatus 200 according to an embodiment of the present invention calculates a color shift vector from an edge extracted from a color channel of an input image captured by an MCA camera in operation S1110. That is, the depth information estimation apparatus 200 according to an embodiment of the present invention calculates the color shift vector from an edge extracted from the color channel of the input image with respect to a red color channel by using a normalized cross correlation (NCC) combined with a color shifting mask map (CSMM).

Subsequently, the depth information estimation apparatus 200 according to an embodiment of the present invention estimates a sparse depth map for the input image by using the color shift vector in operation S1120. That is, the depth information estimation apparatus 200 according to an embodiment of the present invention estimates the sparse depth map from the color shift vector as expressed in Equation 14 above.

Subsequently, the depth information estimation apparatus 200 according to an embodiment of the present invention estimates a full depth map from the sparse depth map by using the depth interpolation method in operation S1130. That is, the depth information estimation apparatus 200 according to an embodiment of the present invention estimates the full depth map by filling a remaining portion of an image by using a matting Laplacian method, in order to generate the full depth map using the sparse depth map detected in the edge region.

Subsequently, the depth information estimation apparatus 200 corrects the input image by using the estimated full depth map in operation S1140. For example, the depth information estimation apparatus 200 corrects the input image to a color-matched image by shifting a color channel of the input image by using the full depth map. The depth information estimation apparatus 200 may correct the input image to a 3D image by using the full depth map.

The invention can also be implemented as computer-readable codes on a computer-readable recording medium. The computer-readable recording medium includes all kinds of recording devices for storing data which can be thereafter read by a computer device. Examples of the computer-readable recording medium include a ROM, a RAM, a CD-ROM, a magnetic tape, a floppy disk, and an optical data storage. Further, the computer-readable recording medium may be implemented in the form of a carrier wave such as Internet transmission. Also, the computer-readable recording medium is distributed to computer devices that are connected over the wired/wireless communication networks so that the computer-readable codes may be stored and executed in a distributed fashion.

While the present invention has been particularly shown and described with reference to preferred embodiments thereof, it should not be construed as being limited to the embodiments set forth herein. It will be understood by those skilled in the art that various changes in form and details may be made to the described embodiments without departing from the spirit and scope of the present invention as defined by the following claims.

1. A depth information estimation apparatus comprising:
a color shift vector calculation unit configured to calculate a color shift vector indicating a degree of color channel shift in an edge region extracted from color channels of an input image captured by an imaging device having different color filters installed in a plurality of openings formed in an aperture; and
a depth map estimation unit configured to estimate a sparse depth map for the edge region by using a value of the estimated color shift vector, and interpolate depth information on a remaining region other than the edge region of the input image based on the sparse depth map to estimate a full depth map for the input image.

2. The apparatus of claim 1, wherein the depth map estimation unit estimates the full depth map from the sparse depth map as expressed in Equation A below:
d=(L+λA)⁻¹λ\hat{d} [Equation A]
where, d is a full depth map, L is a matting Laplacian matrix, A is a constant for controlling fidelity between smoothness of interpolation and a sparse depth map, A is a diagonal matrix in which Aᵢᵢ is equal to 1 if an i-th pixel is on an edge and Aᵢᵢ is equal to 0 if an i-th pixel is not on an edge, and \hat{d} is a sparse depth map.

3. The apparatus of claim 1, wherein the depth map estimation unit estimates the sparse depth map from the color shift vector as expressed in Equation B below:
D(x,y)=−sign(v)×\sqrt{u²+v²} [Equation B]
where, (u,v) is a color shift vector estimated at (x,y), and sign(v) is a sign of v.

4. The apparatus of claim 1, wherein the color shift vector calculation unit calculates the color shift vector in the extracted edge region under a constraint of a color shifting mask map (CSMM) predetermined based on a color shift property of the aperture in which a color is shifted in a predetermined form.

5. The apparatus claim 1, further comprising an image correction unit configured to correct the input image to a color-matched image by shifting the color channel of the input image by using the full depth map.

6. A depth information estimation method comprising:
calculating a color shift vector indicating a degree of color channel shift in an edge region extracted from color channels of an input image captured by an imaging device having different color filters installed in a plurality of openings formed in an aperture;
estimating a sparse depth map for the edge region by using a value of the estimated color shift vector; and
interpolating depth information on a remaining region other than the edge region of the input image based on the sparse depth map to estimate a full depth map for the input image.

7. The method of claim 6, wherein the full depth map estimation step estimates the full depth map from the sparse depth map as expressed in Equation (A) below:
d=(L+λA)⁻¹λ\hat{d} [Equation A]
where, d is a full depth map, L is a matting Laplacian matrix, λ is a constant for controlling fidelity between smoothness of interpolation and a sparse depth map, A is a diagonal matrix in which Aᵢᵢ is equal to 1 if an i-th pixel is on an edge and Aᵢᵢ is equal to 0 if an i-th pixel is not on an edge, and \hat{d} is a sparse depth map.

8. The method of claim 6, wherein the sparse depth map estimation step estimates the sparse depth map from the color shift vector as expressed in Equation (B) below:
D(x,y)=−sign(v)×\sqrt{u²+v²} [Equation B]
where, (u,v) is a color shift vector estimated at (x,y), and sign(v) is a sign of v.

9. The method of claim 6, wherein the color shift vector calculation step calculates the color shift vector in the extracted edge region under a constraint of a color shifting mask map (CSMM) predetermined based on a color shift property of the aperture in which a color is shifted in a predetermined form.

10. The method of claim 6, further comprising correcting the input image to a color-matched image by shifting the color channel of the input image by using the full depth map.

11. A non-transitory computer readable recording medium recoding a program for executing the method of claim 6.
